(19) United States
(12) Patent Application Publication
(10) Pub. No.: US 2025/0254762 A1
(43) Pub. Date: Aug. 7, 2025

(54) SYSTEMS AND METHODS FOR HEATER ASSEMBLIES

(71) Applicant: Agilent Technologies, Inc., Santa Clara, CA (US)

(72) Inventors: Richard WHITE, Santa Clara, CA (US); Wesley NORMAN, Santa Clara, CA (US)

(73) Assignee: Agilent Technologies, Inc., Santa Clara, CA (US)

(21) Appl. No.: 18/431,878

(22) Filed: Feb. 2, 2024

(51) Int. Cl. H05B 3/06; G01N 30/02; G01N 30/30

(52) U.S. Cl. CPC H05B 3/06; G01N 30/30; G01N 2030/025; G01N 2030/3053; G01N 2030/3084; H05B 2203/014; H05B 2203/017; H05B 2203/022; H05B 2203/033

(57) ABSTRACT

Systems and methods for heater assemblies are described herein. A gas chromatography device can include a heater assembly. The heater assembly can include a plate. The plate can have an inner diameter, an outer diameter, a planar surface, and a curved surface. The heater assembly can include a wire. The wire can form a plurality of coils around the inner diameter and the outer diameter of the plate. Each of the plurality of coils can have a diameter greater than half of a difference between the outer diameter of the plate and the inner diameter of the plate. Each of the plurality of coils can be configured to intersect the inner diameter of the plate and the outer diameter of the plate. An aspect ratio of half of the difference between the outer diameter of the plate and the inner diameter of the plate to a thickness of the plate is greater than 1. The device can include a mounting piece configured to couple with the heater assembly.

### TECHNICAL FIELD

The present application relates generally to gas chromatography.

### BACKGROUND

Gas chromatography (GC) is used to analyze and detect the presence of many different substances in a sample. The function of a gas chromatograph is to separate the components of a chemical sample, known as analytes, and detect the identity and/or the concentration of those components. The separation is frequently accomplished using a capillary GC column. In some instances, this column is essentially a piece of fused silica tubing with a stationary phase coating on the inside that interacts with the sample to separate the components. A pressurized gas, known as the mobile phase, is used to transport the sample through the column. The GC column can remain isothermal throughout an analysis or be ramped in temperature to aid in separation or shorten analysis time.

### SUMMARY

Operating a gas chromatography instrument can involve heating an oven using heater coils. During normal operation (e.g., heating the oven to temperatures between 350° C. and 450° C.) or during tests (e.g., heating the oven to temperatures greater than 450° C.) of the instrument, the heater coils may become displaced from their original or as-manufactured positions. The heater coils can sag, move around, and/or collapse, which can lead to an electrical short circuit or hot spots. This can reduce the lifetime of the instrument. The solutions described herein can provide a heater assembly. The heater assembly can include a support for the heating coils such that the heating coils are prevented from sagging or collapsing.

At least one aspect of the present disclosure is directed to a heater assembly. The heater assembly can include a plate. The plate can have an inner diameter, an outer diameter, a planar surface, and a curved surface. The heater assembly can include a wire. The wire can form a plurality of coils around the inner diameter and the outer diameter of the plate. Each of the plurality of coils can have a diameter greater than half of a difference between the outer diameter of the plate and the inner diameter of the plate. Each of the plurality of coils can be configured to intersect the inner diameter of the plate and the outer diameter of the plate. A radial width is defined by half of the difference between the outer diameter of the plate and the inner diameter of the plate, the radial width greater than a thickness of the plate.

Another aspect of the present disclosure is directed to a GC device. The GC device can include a heater assembly. The heater assembly can include a plate. The plate can have an inner diameter, an outer diameter, a planar surface, and a curved surface. The heater assembly can include a wire. The wire can form a plurality of coils around the inner diameter and the outer diameter of the plate. Each of the plurality of coils can have a diameter greater than half of a difference between the outer diameter of the plate and the inner diameter of the plate. Each of the plurality of coils can be configured to intersect the inner diameter of the plate and the outer diameter of the plate. A radial width is defined by half of the difference between the outer diameter of the plate and the inner diameter of the plate, the radial width greater than a thickness of the plate. The GC device can include a mounting piece configured to couple with the heater assembly.

Another aspect of the present disclosure is directed to a method. The method can include providing a plate having an inner diameter, an outer diameter, a planar surface, and a curved surface. The method can include providing a wire configured to form a plurality of coils around the plate. Each of the plurality of coils can have a diameter greater than half of a difference between the outer diameter of the plate and the inner diameter of the plate. Each of the plurality of coils can be configured to intersect the inner diameter of the plate and the outer diameter of the plate. A radial width is defined by half of the difference between the outer diameter of the plate and the inner diameter of the plate, the radial width greater than a thickness of the plate.

Those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1 is a schematic diagram of a gas chromatography system in accordance with an embodiment.

FIG. 2 is a diagram of a portion of the gas chromatography system in accordance with an embodiment.

FIG. 3 is a diagram of a portion of the gas chromatography system in accordance with an embodiment.

FIG. 4 is a schematic diagram of portions of a plate in accordance with an embodiment.

FIG. 5 is a schematic diagram of portions of the plate in accordance with an embodiment.

FIG. 6 is a schematic flow diagram illustrating a method for providing a heater assembly in accordance with an embodiment.

Like reference numbers and designations in the various drawings indicate like elements.

### DETAILED DESCRIPTION

Following below are more detailed descriptions of various concepts related to, and implementations of, methods, apparatuses, and systems for a heater assembly. The various concepts introduced above and discussed in greater detail below may be implemented in any of a number of ways, as the described concepts are not limited to any particular manner of implementation. Examples of specific implementations and applications are provided primarily for illustrative purposes.

Oven heater assemblies for gas chromatographs (e.g., 200 V AC gas chromatographs) can be prone to failure at maximum power. Below maximum power, the wire of the heater assembly can sag, which can lead to bunching of adjacent coils (e.g., heater coils) and/or hot spots. A short circuit to the frame and collapsed coils contacting neighboring coils may lead to high current and hotter local temperatures. When the heater coil fails, this can cause issues when the heater coil comes into contact with the oven walls. Additionally, this can cause subsequent problems with high-potential tests. Additionally, runaway tests can require full power for an extended time. Failure of the heater assembly under these conditions can involve sagging and possible melting of the heater coils. High temperature air bath convective ovens can fail due to oven coil elements that short to the support structure, the circulating fan, and/or adjacent coils. High power density can cause oven coil elements to overheat and sag or melt. Testing can be performed at extreme conditions. If the above failure method occurs, it would be beneficial if failed oven coil elements do not form a short circuit.

Gas chromatographs can use a quartz ring to support heater coils. However, quartz rings may be expensive and difficult to manufacture and assemble. Additionally, quartz can have a high thermal mass and be fragile. Gas chromatograph air bath ovens can be intended to ramp up and down in temperature quickly. Therefore, they may benefit from low mass responsive heaters.

The present disclosure is directed to systems and methods for heater assemblies. A support (e.g., mica ring) can support a helical heater coil and enable more robust performance at extreme power density and high (e.g., greater than 450° C.) air bath oven temperatures. A lightweight mica disc at the equator of the helical oven coil can stabilize the construction so the heater assembly (e.g., coils) remain properly spaced and optimally performing even when subjected to extreme temperatures and power levels. If one or more coils fail, broken coils can remain on the mica support, preventing short circuits and failure issues.

The disclosed solutions have a technical advantage of providing a heater assembly that keeps individual coils from migrating together between ceramic and insulating supports. The disk (e.g., ring, mica disk, mica ring) can contact each coil and keep the coil at the intended pitch spacing. Compared to a quartz ring, the mica ring can be lighter and have a lower thermal mass. Mica can support some fracture without losing the integrity of the equatorial disk. The disk can have a low profile and limited contact area, so the power density of the heater wire can be maximized. The disk can help to maximize the number of coils between ceramic supports. The disk can support coils in a toroid, rather than allow the coils to run straight between supports. This can keep the coils (e.g., helix) in the toroid (e.g., torus) form and prevent shorts to the supporting structure of adjacent moving parts (e.g., a fan).

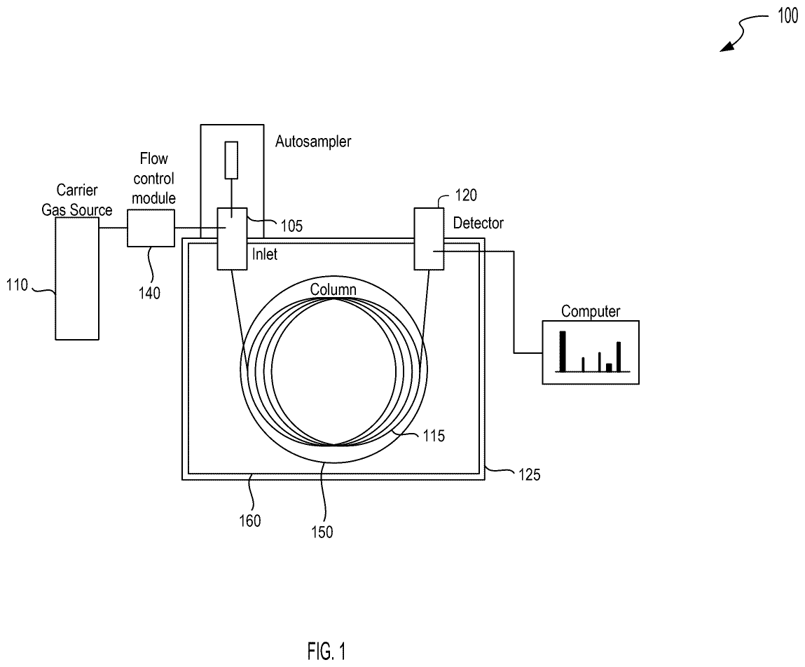

FIG. 1 is a schematic diagram of a gas chromatography system 100 (GC system, GC device). The GC system 100 can include a representative GC system. The GC system 100 can include one or more injection ports 105 (e.g., inlet, sample inlet). The injection port 105 can receive a sample injected into the GC system 100 for analysis. For example, the sample can be injected into the injection port 105 where, if not already in a gaseous state, it is vaporized into the gaseous state for analysis by the GC system 100.

The GC system 100 can include one or more pressurized gas sources 110 (e.g., pressurized gas supply, gas source, gas supply, supply gas). The pressurized gas source 110 can include a tank. The pressurized gas source 110 (e.g., carrier gas supply, carrier gas source, carrier gas) can be fluidly (e.g., fluidically) coupled with (e.g., connected to) the injection port 105. The pressurized gas source 110 can supply a carrier gas, such as but not limited to, helium, hydrogen, nitrogen, an argon/methane mixture, or other such inert gas, that transports the injected sample from the injection port 105 through the GC system 100. The pressurized gas source 110 can include a source of pressurized gas. The pressurized gas source 110 can be a gas distribution system of pressurized gases. The pressurized gases can be found in a laboratory. The pressurized gas source 110 can include multiple gases. The pressurized gas source 110 can be coupled with the GC system 100 via a distribution panel.

The GC system 100 can include one or more electronic pneumatic control (EPC) modules 140 (e.g., flow control modules). The electronic pneumatic control module 140 can be coupled with (e.g., connected to) the pressurized gas source 110. The electronic pneumatic control module 140 can be fluidly coupled with the injection port 105. For example, the injection port 105 can be attached to the electronic pneumatic control module 140. The electronic pneumatic control module 140 can control the flow and/or pressure of the injection port 105. The carrier gas can go to a first electronic pneumatic control module before going to the injection port 105. Each inlet can have its own electronic pneumatic control module 140. Each electronic pneumatic control module 140 can be coupled with the same gas supply or different gas supplies.

The GC system 100 can include one or more columns 115 (e.g., tube, restrictor, separation column). The column 115 can be fluidly coupled with the injection port 105. The column 115 can be selected from a wide variety of columns utilized to achieve separation of components of a sample by gas chromatography. Gas chromatographs configured for backflushing, detector splitting, or other pneumatic switching can include multiple columns 115. The carrier gas can transport the sample from the injection port 105 to the column 115 for separation. The column 115 can separate the components of the gaseous sample to produce one or more analytes of interest for analysis by the GC system 100. The column 115 can include a capillary column and/or may include fused silica tubing with a coating (e.g., stationary phase coating) on the inner portions of the tubing that interacts with the sample injected into the injection port 105 to separate the components of the sample. The column 115 can be made of metal. Dimensions of the column 115 can include an inner diameter range of 50 μm (microns) to 530 μm and a length range of up to 200 meters. The injection port 105 can provide samples to the column 115 for separation. The column 115 can include a separation column or a column that serves as a restrictor fluidically connected to a separation column.

The GC system 100 can include one or more detectors 120. The detector 120 can receive the separated components (e.g., analytes of the sample) after the sample is transported through the column 115. The detector 120 can be fluidly coupled with the column 115. The detector 120 can analyze the separated sample components to detect the presence and/or the quantity of sample analytes separated by the column 115. The detector 120 can include a flame ionization detector (FID), a mass selective detector (MSD), a thermal conductivity detector (TCD), an electron capture detector (ECD), a nitrogen phosphorus detector (NPD), a sulfur chemiluminescence detector (SCD), a nitrogen chemiluminescence detector (NCD), a flame photometric detector (FPD), or a helium ionization detector (HID), among others. The detector 120 can be coupled with a computer. The computer can process and/or display data from the detector 120.

The GC system 100 can include one or more column heaters 125. The column heater 125 can include an oven, a convection heater, a conduction heater, an air bath, or other such heating device for heating certain components of the GC system 100. The column heater 125 can heat or cool the column 115 and other flow path components to desired temperatures. The column heater 125 can be configured to heat the column 115 such that the column 115 remains isothermal during sample analysis.

The GC system 100 can include one or more controllers (not shown). The controller can be communicably connected, directly or indirectly, to the column heater 125, the injection port 105, one or more sensors, and/or other components of the GC system 100. The controller can be electrically coupled with the GC system 100. The controller can be an onboard computing component that is physically incorporated into the housing of the GC system 100 that contains the column 115, column heater 125, and other components of the GC system 100. The controller can be one or more separate computing devices and/or other such controlling devices that are internal and/or external to the housing of the GC system 100. The controller or a portion of the controller can reside within the GC system 100. For example, the controller or a portion of the controller can be disposed in the GC system 100. The controller can be split between multiple locations. The controller can be disposed outside of the GC system 100.

The controller can include one or more processors, such as but not limited to, a single-core processor, a multi-core processor, a logic device, or other such data processing circuitry, configured to execute, analyze, and process data and information of the GC system 100. The controller can include a non-transitory memory device communicably connected to the processor. The memory device may be configured as a volatile memory device (e.g., SRAM and DRAM), a non-volatile memory device (e.g., flash memory, ROM, and hard disk drive), or any combination thereof. The memory device may store executable code and other such information that is generated and/or processed by the processor during operation of the GC system 100.

The GC system 100 can include one or more input/output devices communicably connected to the controller. The input/output device can enable an operator and/or user to receive information from the controller and to input information and parameters into the controller. Such information and parameters can be stored in the memory device, accessed by the processor, and output to the input/output device. For example, the input/output device can include a monitor, display device, touchscreen device, keyboard, microphone, joystick, dial, button, or other such device to enable input and output of information and parameters. The input/output device may be utilized to input information into the controller and output or otherwise display information and data generated by the processor of the GC system 100.

The GC system 100 can include one or more heater assemblies 150 (e.g., heating assembly). The heater assembly 150 can include one or more heater coils. The heater assembly 150 can have a diameter that is the same as or larger than the diameter of a loop or circle formed by the column 115. The diameter of the heater assembly 150 can be smaller than the loop or circle formed by the diameter of the column 115. The heater assembly 150 can heat the oven. For example, the heater assembly 150 can increase the temperature of the oven. The column heater 125 can include the heater assembly 150.

The GC system 100 can include one or more mounting pieces 160. The mounting piece 160 can be coupled with the heater assembly 150. The mounting piece 160 can be disposed on the back wall of the oven. The mounting piece 160 can form the back wall of the oven. The mounting piece 160 can have a plurality of holes. The holes can allow airflow between the space with the heater assembly 150 and the rest of the oven. The length and width of the mounting piece 160 can be the same as the length and width of the oven. The mounting piece 160 can couple with the heater assembly 150.

The mounting piece 160 can be made of one or more materials such as iron, steel (e.g., stainless steel). The material of the mounting piece 160 can be suitable for normal operation (e.g., up to 450° C. or more), exposure to high temperatures (e.g., excess of 1000° C.) due to proximity to heater coils, and/or extreme temperatures during testing. The material of the mounting piece 160 can be for cost and/or manufacturability.

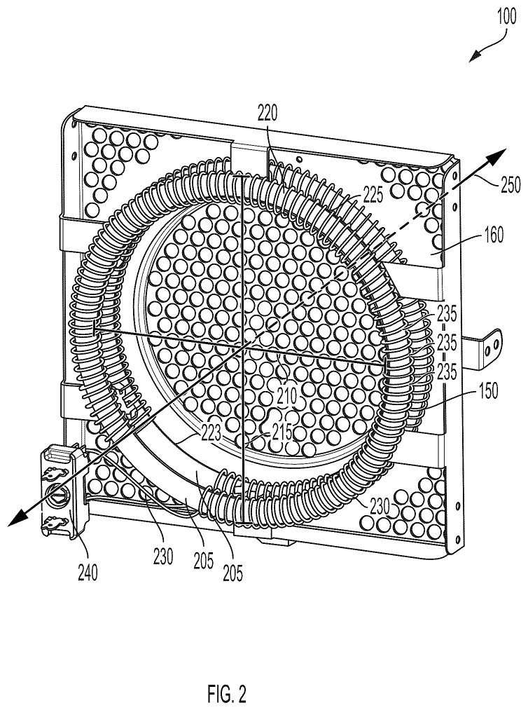

FIG. 2 is a diagram of a portion of GC system 100. The GC system 100 can include the mounting piece 160. The GC system 100 can include the heater assembly 150. The heater assembly 150 can include one or more plates 205. The plate 205 can include (e.g., be made of) a ceramic. The plate 205 can include mica. The plate 205 can include alumina, alumina silicate, silica, or quartz. The plate 205 can be electrically insulating. The plate 205 can be electrically non-conductive. The plate 205 can be cut from a single piece of material. The plate 205 can remain flat, as opposed to being shaped, bent, or deformed. The plate 205 can be free of any strain due to elastic or plastic deformation. The plate 205 can have a variety of shapes. For example, the plate 205 can be circular. The plate 205 can be ring-shaped. For example, the plate 205 can include a planar ring. The plate 205 can be an annulus. For example, the plate 205 can be an annulus with a measurable thickness. The plate 205 can be symmetric (e.g., radially symmetric). The plate 205 can remain flat (e.g., planar) in contrast to being bent or coiled. The plate 205 can be flat and unstressed. The surface of the plate 205 that has the largest surface area on the plate 205 can be perpendicular to the central axis 250. The plate 205 can be cut (e.g., die-cut) from a sheet of mica. The plate 205 can be cut so that the plate 205 can be displaced (e.g., bent) out of plane. The plate 205 can be sliced radially such that the plate 205 can be bent out of plane to form a screw or inclined plane, facilitate assembly, and/or allow other geometric configurations of heater coil support.

The plate 205 can be configured to melt at a temperature of greater than 1000° C. The plate 205 can have a melting point of greater than or equal to 1000° C. For example, the plate 205 can have a melting point of greater than or equal to 1000° C., greater than or equal to 1100° C., greater than or equal to 1200° C., greater than or equal to 1300° C., greater than or equal to 1400° C., or greater than or equal to 1500° C. The plate 205 can be made of a material with a melting point of greater than or equal to 1000° C. For example, the plate 205 can be made of a material with a melting point of greater than or equal to 1000° C., greater than or equal to 1100° C., greater than or equal to 1200° C., greater than or equal to 1300° C., greater than or equal to 1400° C., or greater than or equal to 1500° C. The plate 205 can be configured to melt at a temperature of less than 1000° C.

The plate 205 can have an inner diameter 210. The inner diameter 210 can include a distance between a first point on an inner edge of the plate 205 and a second point on the inner edge of the plate 205. The first point on the inner edge of the plate 205 can be disposed opposite the second point on the inner edge of the plate 205. The inner diameter 210 can pass through a center of the plate 205. The inner diameter 210 can include the smallest distance between two points on the inner edge of the plate 205. The inner diameter 210 of the plate 205 can be in a range of 125 mm to 160 mm. For example, the inner diameter 210 of the plate 205 can be in a range of 125 mm to 135 mm, 125 mm to 140 mm, 125 mm to 145 mm, 125 mm to 150 mm, 125 mm to 155 mm, 125 mm to 160 mm, 135 mm to 140 mm, 135 mm to 145 mm, 135 mm to 150 mm, 135 mm to 155 mm, 135 mm to 160 mm, 140 mm to 145 mm, 140 mm to 150 mm, 140 mm to 155 mm, 140 mm to 160 mm, 145 mm to 150 mm, 145 mm to 155 mm, 145 mm to 160 mm, 150 mm to 155 mm, 150 mm to 160 mm, or 155 mm to 160 mm. The inner diameter 210 of the plate 205 can be less than 135 mm. The inner diameter 210 of the plate 205 can be greater than 160 mm.

The plate 205 can have an outer diameter 215. The outer diameter 215 can include a distance between a first point on an outer edge of the plate 205 and a second point on the outer edge of the plate 205. The first point on the outer edge of the plate 205 can be disposed opposite the second point on the outer edge of the plate 205. The outer diameter 215 can pass through the center of the plate 205. The outer diameter 215 can include the largest distance between two points on the outer edge of the plate 205. The outer diameter 215 of the plate 205 can be in a range of 140 mm to 175 mm. For example, the outer diameter 215 of the plate 205 can be in a range of 140 mm to 145 mm, 140 mm to 150 mm, 140 mm to 155 mm, 140 mm to 160 mm, 140 mm to 165 mm, 140 mm to 170 mm, 140 mm to 175 mm, 145 mm to 150 mm, 145 mm to 155 mm, 145 mm to 160 mm, 145 mm to 165 mm, 145 mm to 170 mm, 145 mm to 175 mm, 150 mm to 155 mm, 150 mm to 160 mm, 150 mm to 165 mm, 150 mm to 170 mm, 150 mm to 175 mm, 155 mm to 160 mm, 155 mm to 165 mm, 155 mm to 170 mm, 155 mm to 175 mm, 160 mm to 165 mm, 160 mm to 170 mm, 160 mm to 175 mm, 165 mm to 170 mm, 165 mm to 175 mm, or 170 mm to 175 mm. The outer diameter 215 of the plate 205 can be less than 140 mm. The outer diameter 215 of the plate 205 can be greater than 175 mm. The outer diameter 215 can be larger than the inner diameter 210. The inner diameter 210 can be smaller than the outer diameter 215.

The difference between the outer diameter 215 of the plate 205 and the inner diameter 210 of the plate 205 can be greater than 10 mm. For example, the difference between the outer diameter 215 of the plate 205 and the inner diameter 210 of the plate 205 can be greater than 10 mm, greater than 11 mm, greater than 12 mm, greater than 13 mm, greater than 14 mm, greater than 15 mm, greater than 20 mm, greater than 25 mm, or greater than 30 mm. The difference between the outer diameter 215 of the plate 205 and the inner diameter 210 of the plate 205 can be less than or equal to 10 mm.

The plate 205 can have one or more surfaces. For example, the plate 205 can have one or more planar surfaces 220. For example, the plate 205 can include an inner planar surface and an outer planar surface. The planar surface 220 can be parallel to the mounting piece 160. For example, the planar surface 220 can be parallel to a surface of the mounting piece 160 with the largest surface area. The plate 205 can be disposed in the GC system 100 such that the planar surface 220 is parallel to a sidewall of the oven. The planar surface 220 can include a surface of the plate 205 with the largest surface area compared with other surfaces of the plate 205. The planar surface 220 can be perpendicular to a central axis 250. The central axis 250 can include a central axis of the inner diameter 210. The central axis 250 can include a central axis of the outer diameter 215. The central axis of the inner diameter 210 can be offset from the central axis of the outer diameter 215. The central axis of the inner diameter 210 can be aligned with the central axis of the outer diameter 215. The planar surface 220 can be perpendicular to the central axis of the inner diameter 210. The planar surface 220 can be perpendicular to the central axis of the outer diameter 215. The surface of the plate 205 that has the largest surface area on the plate 205 can be perpendicular to the central axis 250 of the inner diameter 210. The surface of the plate 205 that has the largest surface area on the plate 205 can be perpendicular to the central axis 250 of the outer diameter 215.

The plate 205 can have one or more curved surfaces. For example, the plate 205 can include an inner curved surface 223 and an outer curved surface 225. The curved surface can be perpendicular to the mounting piece 160. For example, the curved surface can be perpendicular to the surface of the mounting piece 160 with the largest surface area. The plate 205 can be disposed in the GC system 100 such that the curved surface is perpendicular to the sidewall of the oven. The curved surface can include the surface of the plate 205 with the smallest surface area compared to other surfaces of the plate 205. The curved surface can be parallel to the central axis 250. For example, the curved surface can be parallel to the central axis of the inner diameter 210. The curved surface can be parallel to the central axis of the outer diameter 215. A surface area of the curved surface can be less than a surface area of the planar surface 220. The surface area of the planar surface 220 can be greater than the surface area of the curved surface. The plate 205 can have one or more circular edges.

The heater assembly 150 can include one or more wires 230 (e.g., heater wire). The wire 230 can include (e.g., be made of) nickel and chromium. For example, the wire 230 can be made of nichrome. The wire 230 can have a melting point that is less than the melting point of the plate 205. The melting point of the plate 205 can be greater than the melting point of the wire 230. The wire 230 can extend from one plate to another plate.

The wire 230 can form a plurality of coils 235 (e.g., heater coils). For example, the wire 230 can form the plurality of coils 235 around the plate 205. The plurality of coils 235 can be wrapped around the plate 205. For example, the plurality of coils 235 can be wrapped around the plate 205 such that the wire 230 goes from the inner diameter 210 to the outer diameter 215. The plurality of coils 235 can be wrapped around the plate 205 such that the wire 230 goes from the inner diameter 210 to the outer diameter 215 and back again for each coil of the plurality of coils 235. The plurality of coils 235 can be wrapped around the plate 205 such that the wire 230 goes from the inner diameter 210 to the outer diameter 215 and back again on each individual coil of the plurality of coils 235. The plurality of coils 235 can be coupled with the plate 205. For example, the plurality of coils 235 can physically contact the plate 205. The plurality of coils 235 can form one or more toroids. The plate 205 can be configured to provide a frictional component to prevent the plurality of coils 235 from sagging or moving.

The spacing between the plurality of coils 235 can be the same or different. A pitch of the plurality of coils 235 can include the spacing between the plurality of coils 235. The pitch of the plurality of coils 235 can include the spacing between the plurality of coils plus the diameter of the wire 230. The plurality of coils 235 can be uniform or non-uniform. The pitch can be in a range of 2 times the diameter of the wire 230 to 4 times the diameter of the wire 230.

The plate 205 can fit inside the plurality of coils 235. The plurality of coils 235 can include a helical coil (e.g., helical coil of the heater assembly wire). The plate 205 can slide inside the plurality of coils 235. The plate 205 can lace the entire perimeter of the heater assembly 150 on its equator. The plate 205 can be threaded inside the plurality of coils 235. For example, the plate 205 can be threaded inside the plurality of coils 235 to support the hot heater wires. the plate 205 can be threaded inside the plurality of coils 235 to minimize migration of the plurality of coils 235. If one of plurality of coils 235 fail, the individual coil can remain supported by the plate 205 instead of causing a short. The plate 205 can be disposed along the equator of the plurality of coils 235. The plurality of coils 235 can be kept aligned. Failed coils can sag or move due to gravity when they are hot. Keeping the plurality of coils 235 from shorting to adjacent coils can avoid issues due to increased current when shorted. The plate 205 can be disposed at the equator of the toroid formed by the plurality of coils 235. The plate 205 can prevent a short circuit to the frame (e.g., mounting piece 160) or adjacent coil. The plate 205 can cause the plurality of coils 235 to fail in a predetermined manner. When the plurality of coils 235 start to move or sag, the plurality of coils 235 can touch the edge (e.g., outer edge, inner edge) of the plate 205. When the plurality of coils 235 start to move or sag, the plurality of coils 235 can find a resting point on the plate 205. The plate 205 can stabilize the plurality of coils 235. The plate 205 can prevent the plurality of coils 235 from sliding and collecting in a bundle.

The plurality of coils 235 can be separated from the plate 205. For example, there can be a gap between each of the plurality of coils 235 and the plate 205. Each of the plurality of coils 235 can be separated from the outer edge of the plate 205 and/or the inner edge of the plate 205. Each of the plurality of coils 235 can be in contact with the plate 205. For example, each of the plurality of coils 235 can be in contact with the outer edge of the plate 205 and/or the inner edge of the plate 205. The plate 205 can have one or more edges in contact with each of the plurality of coils 235. Friction between the plurality of coils 235 and the plate 205 can prevent or limit the plurality of coils 235 from moving. For example, friction between the plurality of coils 235 and the plate 205 can prevent or limit the plurality of coils 235 from moving more than a threshold distance. The plurality of coils 235 can be constrained radially (to a diameter of the plate 205). The plurality of coils 235 can be constrained axially (along a minor diameter of the toroid formed by the plurality of coils 235).

Each of the plurality of coils 235 can be configured to intersect the inner diameter 210 of the plate 205 and the outer diameter 215 of the plate 205. For example, each of the plurality of coils 235 can be wrapped around the plate 205 such that each of the plurality of coils 235 intersects the inner diameter 210 of the plate 205. Each of the plurality of coils 235 can be wrapped around the plate 205 such that each of the plurality of coils 235 intersects the outer diameter 215 of the plate 205.

The GC system 100 can include one or more fans. The fan can be disposed at or near a center of the plate 205. The fan can be disposed in an interior of the plate 205. The fan can provide cooling to the GC system 100. The fan can provide mixing to allow for uniform temperature for the air bath oven. The fan can mix and/or exchange air. The fan can dissipate heat generated by the plurality of coils 235. The fan can be disposed proximate to the center of the plate 205.

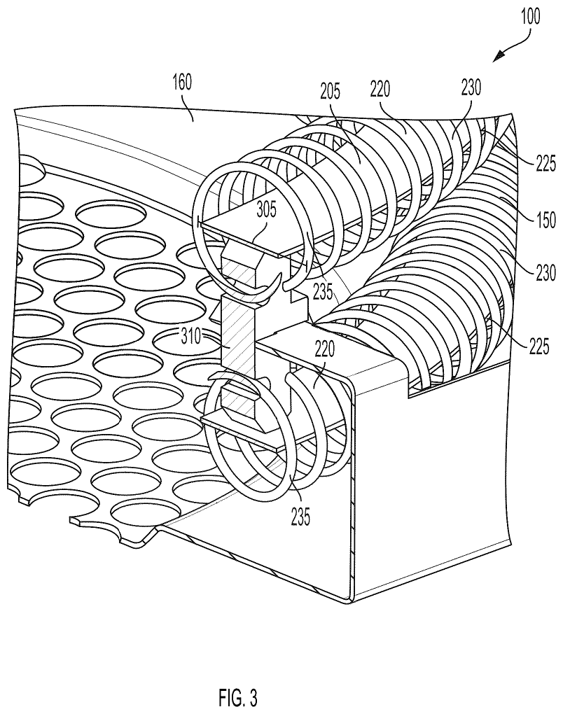

FIG. 3 is a schematic diagram of a portion of the GC system 100. The GC system 100 can include the mounting piece 160, the plate 205, and the plurality of coils 235. The plate 205 can include the planar surface 220 and the curved surface.

Each of the plurality of coils 235 can have a diameter (e.g., coil diameter 305). Each of the plurality of coils 235 can have a diameter greater than half of a difference between the outer diameter 215 of the plate 205 and the inner diameter 210 of the plate 205. The coil diameter 305 can be greater than half of the difference between the outer diameter 215 of the plate 205 and the inner diameter 210 of the plate 205. The plurality of coils 235 can have a varying diameter. For example, adjacent coils of the plurality of coils 235 can have different diameters. The plate 205 can fit through the plurality of coils 235 without binding. There can be a clearance between the plate 205 and the plurality of coils 235. The plurality of coils 235 can have an average diameter. The average diameter of the plurality of coils 235 can be greater than half of the difference between the outer diameter of the plate 205 and the inner diameter of the plate 205.

The GC system 100 can include one or more locking elements 310 (e.g., locking component, spacing component, positioning component). The locking element 310 can include a spacing component that locks one or more of the plurality of coils 235 in position. The locking element 310 can couple the plurality of coils 235 with the mounting piece 160. For example, the locking element 310 can contact the plurality of coils 235 and the mounting piece 160. The locking element 310 can couple the mounting piece 160 with one or more of the plurality of coils 235. The locking element 310 can prevent the plurality of coils 235 from moving. The locking element 310 can include a plurality of holes or grooves. The plurality of coils 235 can be threaded into the holes or grooves of the locking element 310. The locking element 310 can separate the first plate and the second plate. The locking element 310 can contact the plate 205. For example, the locking element 310 can contact the first plate. The locking element 310 can contact the second plate. The locking elements 310 can be electrically insulating. The locking element 310 can be made of ceramics. A coil of the plurality of coils 235 can pass through the locking element 310. The locking element 310 can fix the position of one or more of the plurality of coils 235.

Half of the difference between the outer diameter 215 of the plate 205 and the inner diameter 210 of the plate 205 can be a radial width. A radial width is defined by half of the difference between the outer diameter of the plate and the inner diameter of the plate, the radial width greater than a thickness of the plate. The radial width can be greater than the thickness 315. The thickness 315 can be in a range of 0.5 mm to 2.0 mm. For example, the thickness can be in a range of 0.5 mm to 1.0 mm, 0.5 mm to 1.5 mm, 0.5 mm to 2.0 mm, 1 mm to 1.5 mm, 1.0 mm to 2.0 mm, or 1.5 mm to 2.0 mm.

Compared to a plate having a cylinder shape and a radial width less than or equal to the thickness of the plate, the plate 205 with the radial width greater than the thickness 315 of the plate 205 can be more durable and easier to handle and assemble. Additionally, compared to the plate with the radial width less than or equal to the thickness of the plate, the plate 205 with the radial width greater than the thickness 315 of the plate 205 can support the plurality of coils 235 with less contact area and no strain. Compared to the plate with the radial width less than or equal to the thickness of the plate, the plate 205 with the radial width greater than the thickness 315 of the plate 205 can have a higher stiffness in the radial direction (e.g., perpendicular to the central axis 250), which can prevent the plurality of coils 235 from sagging due to gravity. Compared to the plate with the radial width less than or equal to the thickness of the plate, the plate 205 with the radial width greater than the thickness 315 of the plate 205 can have a lower mass and smaller cross section. Compared to the plate with the radial width less than or equal to the thickness of the plate, the plate 205 with the radial width greater than the thickness 315 of the plate 205 can be more flexible in the axial direction.

In some embodiments, the plate 205 can include a first plate and the plurality of coils 235 can include a first plurality of coils. The heater assembly 150 can include a second plate. The second plate can have the same shape as the first plate. The second plate can have a different shape compared to the first plate. The second plate can have an inner diameter, an outer diameter, a planar surface, and a curved surface. The wire 230 can form a second plurality of coils around the second plate. The wire 230 can extend from the first plate to the second plate. The second plate can be disposed a distance from the first plate. The second plate and the first plate can be separated by a distance. The distance can be large enough such that the first plurality of coils do not contact the second plurality of coils.

Each of the second plurality of coils can have a diameter (e.g., coil diameter 305) greater than half of a difference between the outer diameter of the second plate and the inner diameter of the second plate. The coil diameter 305 can be greater than half of the difference between the outer diameter of the second plate and the inner diameter of the second plate. The second plurality of coils can have a varying diameter. For example, adjacent coils of the second plurality of coils can have different diameters. The second plurality of coils can have an average diameter. The average diameter of the second plurality of coils can be greater than half of the difference between the outer diameter of the second plate and the inner diameter of the second plate.

The difference between the outer diameter of the second plate and the inner diameter of the second plate can be greater than 10 mm. For example, the difference between the outer diameter of the second plate and the inner diameter of the second plate can be greater than 10 mm, greater than 11 mm, greater than 12 mm, greater than 13 mm, greater than 14 mm, greater than 15 mm, greater than 20 mm, greater than 25 mm, or greater than 30 mm. The difference between the outer diameter of the second plate and the inner diameter of the second plate can be less than or equal to 10 mm.

The second plurality of coils can be separated from the second plate. For example, there can be a gap between each of the second plurality of coils and the second plate. Each of the second plurality of coils can be separated from the outer edge of the second plate and/or the inner edge of the second plate. Each of the second plurality of coils can be in contact with the second plate. For example, each of the second plurality of coils can be in contact with the outer edge of the second plate and/or the inner edge of the second plate. Friction between the second plurality of coils and the second plate can prevent or limit the second plurality of coils from moving. For example, friction between the second plurality of coils and the second plate can prevent or limit the second plurality of coils from moving more than a threshold distance. The second plurality of coils can be constrained radially (to a diameter of the plate 205). The second plurality of coils can be constrained axially (along a minor diameter of the toroid formed by the plurality of coils).

The GC system 100 can include the heater assembly 150. The heater assembly 150 can include the plate 205. The plate 205 can include the inner diameter 210. The plate 205 can include the outer diameter 215. The plate 205 can include the planar surface 220. The plate 205 can include the curved surface. The heater assembly 150 can include the wire 230. The wire 230 can be configured to form the plurality of coils 235 around the plate 205. Each of the plurality of coils 235 can have a diameter greater than half of a difference between the outer diameter 215 of the plate 205 and the inner diameter 210 of the plate 205. Each of the plurality of coils 235 can be configured to intersect the inner diameter 210 of the plate 205 and the outer diameter 215 of the plate 205. The surface area of the planar surface 220 can be greater than the surface area of the curved surface.

The GC system 100 can include the mounting piece 160. The mounting piece 160 can couple with heater assembly 150. The mounting piece 160 can be disposed on the back wall of the oven. The mounting piece 160 can form the back wall of the oven. The length and width of the mounting piece 160 can be the same as the length and width of the oven.

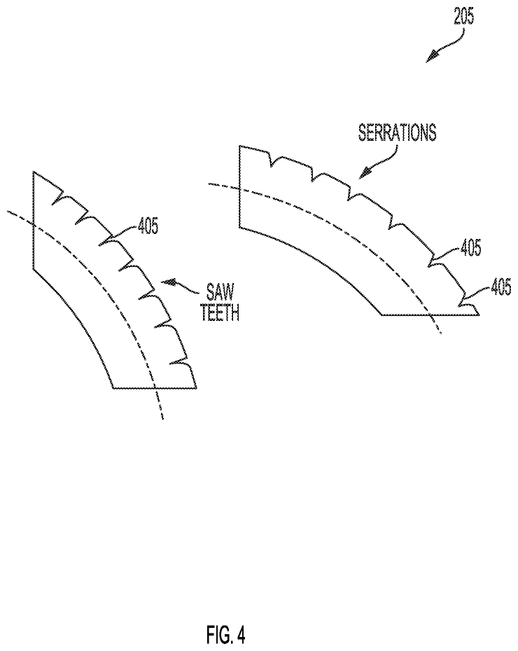

FIG. 4 is a schematic diagram of portions of the plate 205. The plate 205 can include a plurality of notches 405 (e.g., slots). The plurality of notches 405 can be disposed on a portion of the plate 205. For example, the plurality of notches 405 can be disposed on an outer portion of the plate 205. The plurality of notches 405 can be disposed on an inner portion of the plate 205. The plurality of notches 405 can be disposed on the outer edge of the plate 205. The plurality of notches 405 can be disposed on the inner edge of the plate 205. The plurality of notches 405 can form a sawtooth pattern. The sawtooth pattern can allow the plate 205 to be inserted into the plurality of coils 235 more easily in one direction than in the opposite direction. The plurality of coils 235 can slide over the sawtooth edge of the plate 205. The plate 205 can include serrations (e.g., serrated teeth). The serrations may engage the plurality of coils 235. The serrations may prevent sagging or clumping of the plurality of coils 235 along the axis of the toroid formed by the plurality of coils 235. The serrations may allow for a larger width to further constrain the plurality of coils 235 to a target or desired location. The plurality of notches 405 can prevent each of the plurality of coils 235 from moving more than a threshold distance. Each of the plurality of coils 235 can be disposed in each of the plurality of notches 405. The plurality of notches 405 can be coupled with the plurality of coils 235. For example, the plurality of notches 405 can contact (e.g., physically contact) the plurality of coils 235. The portions of the plate 205 that have the plurality of notches 405 can contact the plurality of coils 235. The outer diameter 215 of the plate 205 can include a distance between two notches of the plurality of notches 405. The two notches can be disposed on opposite ends of the plate 205.

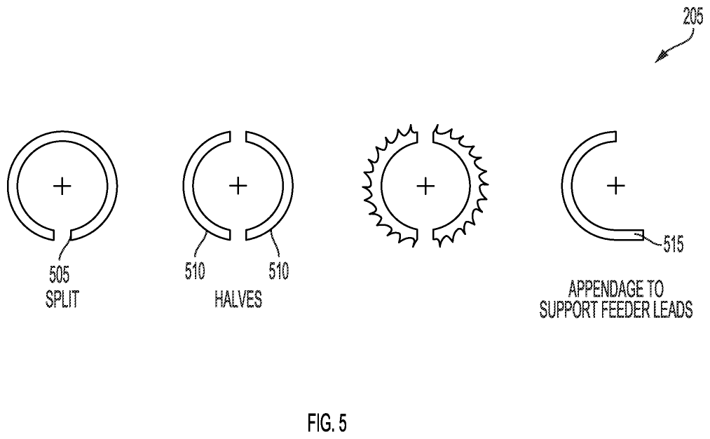

FIG. 5 is a schematic diagram of portions of the plate 205. The plate 205 can include one or more splits 505. For example, the plate 205 can be include one or more breaks along one or more portions of the plate 205. The split 505 can form edges of the plate 205. The split 505 can divide the plate 205 into a plurality of pieces. The split 505 can allow the plate 205 to be insertable into the plurality of coils 235. For example, the plate 205 can be bent out of plane temporarily while inserting the plate 205 into the plurality of coils 235. The split 505 can form a cut through the plate 205 without separating the plate 205 into a plurality of pieces. For example, the plate 205 with the split 505 can be a single piece.

The plate 205 can be divided into halves, thirds, quarters, etc. The plate 205 can include one or more c-shaped plates 510. For example, the plate 205 can include a first c-shaped plate. The plate 205 can include a second c-shaped plate. The heater assembly 150 can include a second c-shaped plate. The c-shaped plates 510 can form two halves of the plate 205. A plurality of plate portions can be coupled together to form the plate 205. For example, the plurality of plate portions can be disposed in the plurality of coils 235. The plurality of plate portions can be serrated or form a sawtooth pattern. For example, an outer edge of the plurality of plate portions can be serrated or form a sawtooth pattern. An inner edge of the plurality of plate portions can be serrated or form a sawtooth pattern.

The plate 205 can include one or more appendages 515. The appendage 515 can support a portion of the wire 230. For example, the appendage 515 can support the portion of the wire 230 configured to extend from the plurality of coils 235. The appendage 515 can support the weight of the portion of the wire 230. Without the appendage 515, the portion of the wire 230 that extends from the plurality of coils 235 may sag. The appendage 515 can locate the heater assembly 150 or anchor the heater assembly 150 with a fastening point. The wire 230 can couple with a plug 240 (e.g., electrical plug). The appendage 515 can support the portion of wire 230 coupled with the plug 240.

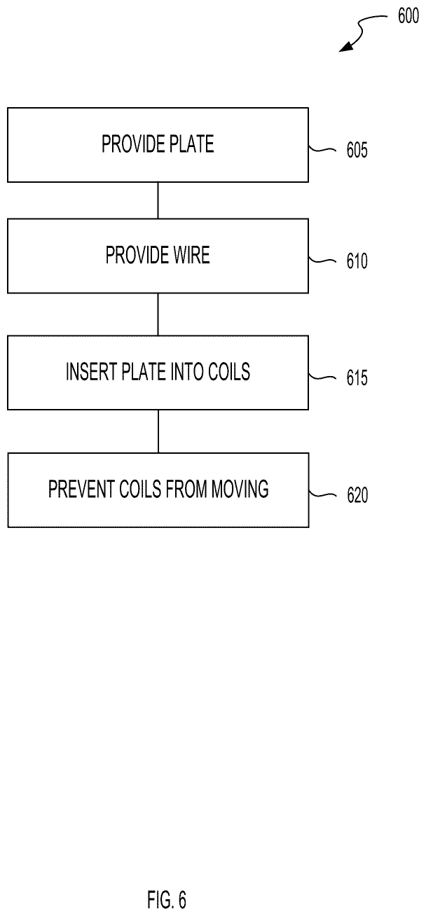

FIG. 6 is a schematic flow diagram illustrating a method 600 for providing a heater assembly. The method 600 can include providing a plate (BLOCK 605). The method 600 can include providing a heater coil (BLOCK 610). The method 600 can include inserting the plate into the coils (BLOCK 615). The method 600 can include preventing the coils from moving (BLOCK 620).

The method 600 can include providing a plate (BLOCK 605). The plate can have an inner diameter, an outer diameter, a planar surface, and a curved surface. The plate can include a first plate. The plate can include a planar ring. The plate can be made of mica. The plate can include a plurality of notches disposed on an outer portion of the plate. The plate can be configured to melt at a temperature of greater than 1000° C. The plate can include a split. The plate can include a first c-shaped plate and a second c-shaped plate. A surface area of the planar surface can be greater than a surface area of the curved surface.

The method 600 can include providing a heater coil (BLOCK 610). The heater coil can form a plurality of coils around the plate. Each of the plurality of coils can have a diameter greater than half of a difference between the outer diameter of the plate and the inner diameter of the plate. Each of the plurality of coils can intersect the inner diameter of the plate and the outer diameter of the plate. A radial width is defined by half of the difference between the outer diameter of the plate and the inner diameter of the plate, the radial width greater than a thickness of the plate. The plurality of coils can include a first plurality of coils. The plate, plurality of coils, mounting piece, and locking elements can form a heater assembly. The method 600 can include providing the heater assembly. The difference between the outer diameter of the plate and the inner diameter of the plate can be greater than 10 mm. The outer diameter of the plate can be in a range of 140 mm to 175 mm. The inner diameter of the plate can be in a range of 125 mm to 160 mm. The plate can include an appendage configured to support a portion of the wire. The portion of the wire can extend from the plurality of coils.

The method 600 can include inserting the plate into the coils (BLOCK 615). For example, the method 600 can include inserting the plate into the plurality of coils. The plate can include a split such that the plate can be inserted into the plurality of coils. The method 600 can include inserting the plate into the plurality of coils before or after the plurality of coils are constrained in a circular (e.g., toroid) configuration. The method 600 can include bending the plate out of plane at the split and inserting the plate into the plurality of coils. The plate can be made of a plurality of pieces such that each piece of the plate can be inserted into the plurality of coils. Inserting the plate into the plurality of coils can include bending the plate out of plane to form a screw or inclined plane and then sliding the plate through the plurality of coils from one end of the plurality of coils. After the wire is wound into a helix to form the plurality of coils, the helix can be bent around a circular form to make a toroid. The helix can have a first opening and a second opening. The split plate can be stretched to form an inclined plane. One end of the plate can be threaded inside the first opening and guided around the toroid minor diameter. The plate can orbit the helix and end up at the second opening. The plate can remain inside the plurality of coils.

The method 600 can include preventing coils from moving (BLOCK 620). For example, the method 600 can include preventing the plurality of coils from moving more than a threshold distance. The method 600 can include preventing the plurality of coils from moving more than a threshold distance after the plate 205 is inserted into the plurality of coils. The method 600 can include limiting the plurality of coils from moving more than the threshold distance. The threshold distance can be less than the distance between two adjacent coils of the plurality of coils. If the plurality of coils move beyond the threshold distance, the plurality of coils may touch and shunt, which can cause a lower resistance and higher current. Shunting of the plurality of coils can lead to a runaway condition. If the plurality of coils move beyond the threshold distance and contact the frame and cause a short circuit. Without the plate 205, the plurality of coils can move beyond the threshold distance.

In some embodiments, the heater assembly can include a second plate having an inner diameter, an outer diameter, a planar surface, and a curved surface. The wire can form a second plurality of coils around the second plate. Each of the second plurality of coils can have a diameter greater than half of a difference between the outer diameter of the second plate and the inner diameter of the second plate.

Any references to implementations or elements or acts of the systems and methods herein referred to in the singular can include implementations including a plurality of these elements, and any references in plural to any implementation or element or act herein can include implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

While operations can be depicted in the drawings in a particular order, such operations are not required to be performed in the particular order shown or in sequential order, and all illustrated operations are not required to be performed. Actions described herein can be performed in a different order.

Any implementation disclosed herein may be combined with any other implementation, and references to “an implementation,” “some implementations,” “an alternate implementation,” “various implementations,” “one implementation” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Elements other than ‘A’ and ‘B’ can also be included.

The systems and methods described herein may be embodied in other specific forms without departing from the characteristics thereof. The foregoing implementations are illustrative rather than limiting of the described systems and methods.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

1. A heater assembly, comprising:
a plate having an inner diameter, an outer diameter, a planar surface, and a curved surface; and
a wire configured to form a plurality of coils around the inner diameter and outer diameter of the plate,
wherein each of the plurality of coils has a diameter greater than half of a difference between the outer diameter of the plate and the inner diameter of the plate,
wherein each of the plurality of coils is configured to intersect the inner diameter of the plate and the outer diameter of the plate, and
wherein a radial width is defined by half of the difference between the outer diameter of the plate and the inner diameter of the plate, the radial width greater than a thickness of the plate.

2. The heater assembly of claim 1, wherein the plate is a first plate and the plurality of coils is a first plurality of coils, the heater assembly further comprising:
a second plate having an inner diameter, an outer diameter, a planar surface, and a curved surface,
wherein the wire is configured to form a second plurality of coils around the second plate, and
wherein each of the second plurality of coils has a diameter greater than half of a difference between the outer diameter of the second plate and the inner diameter of the second plate.

3. The heater assembly of claim 1, wherein the difference between the outer diameter of the plate and the inner diameter of the plate is greater than 10 mm.

4. The heater assembly of claim 1, wherein the outer diameter of the plate is in a range of 140 mm to 175 mm.

5. The heater assembly of claim 1, wherein the inner diameter of the plate is in a range of 125 mm to 160 mm.

6. The heater assembly of claim 1, wherein the plate comprises a planar ring.

7. The heater assembly of claim 1, wherein the plate comprises mica.

8. The heater assembly of claim 1, wherein the plate comprises a plurality of notches disposed on an outer portion of the plate.

9. The heater assembly of claim 1, wherein the plate is configured to melt at a temperature of greater than 1000° C.

10. The heater assembly of claim 1, wherein the plate comprises a split.

11. The heater assembly of claim 1, wherein the plate comprises a first c-shaped plate, the heater assembly further comprising a second c-shaped plate.

12. The heater assembly of claim 1, wherein the plate comprises an appendage configured to support a portion of the wire, the portion of the wire configured to extend from the plurality of coils.

13. A gas chromatography (GC) device, comprising:
the heater assembly of claim 1; and
a mounting piece configured to couple with the heater assembly.

14. The GC device of claim 13, wherein the plate is a first plate and the plurality of coils is a first plurality of coils, the heater assembly further comprising:
a second plate having an inner diameter and an outer diameter,
wherein the wire is configured to form a second plurality of coils around the second plate, and
wherein each of the second plurality of coils has a diameter greater than half of a difference between the outer diameter of the second plate and the inner diameter of the second plate.

15. The GC device of claim 14, further comprising a plurality of locking elements, each of the plurality of locking elements configured to:
couple the mounting piece with one or more of the plurality of coils; and
separate the first plate and the second plate.

16. The GC device of claim 13, further comprising a plurality of locking elements, each of the plurality of locking elements configured to couple the mounting piece with one or more of the plurality of coils.

17. The GC device of claim 13, further comprising a fan disposed near a center of the plate.

18. A method, comprising:
providing a plate having an inner diameter, an outer diameter, a planar surface, and a curved surface; and
providing a wire configured to form a plurality of coils around the inner diameter and the outer diameter of the plate,
wherein each of the plurality of coils has a diameter greater than half of a difference between the outer diameter of the plate and the inner diameter of the plate,
wherein each of the plurality of coils is configured to intersect the inner diameter of the plate and the outer diameter of the plate, and
wherein a radial width is defined by half of the difference between the outer diameter of the plate and the inner diameter of the plate, the radial width greater than a thickness of the plate.

19. The method of claim 18, further comprising:
preventing the plurality of coils from moving more than a threshold distance.

20. The method of claim 18, further comprising:
inserting the plate into the plurality of coils after the plurality of coils are constrained in a circular configuration.

21. The method of claim 18, wherein the plate comprises a split, the method further comprising:
bending the plate out of plane at the split; and
inserting the plate into the plurality of coils.

22. The method of claim 18, further comprising:
inserting the plate into the plurality of coils before the plurality of coils are constrained in a circular configuration.
